(19) United States
(12) Patent Application Publication
(10) Pub. No.: US 2005/0051590 A1
(43) Pub. Date: Mar. 10, 2005

(54) Setting tool

(76) Inventor: Johann Buechel, Sevelen (CH)

Correspondence Address: DAVID TOREN, ESQ.;SIDLEY, AUSTIN, BROWN & WOOD, LLP, 787 SEVENTH AVENUE, NEW YORK, NY, 10019-6018, US

(21) Appl. No.: 10/932,354

(22) Filed: Sep. 1, 2004

(30) Foreign Application Priority Data
Sep. 5, 2003 (DE) 103 41 387.1

(51) Int. Cl. B25C 1/14

(52) U.S. Cl. 227/8; 227/10

(57) ABSTRACT

A setting tool for driving fastening elements into a receiving material has a housing part with a muzzle part (20) on which a pressing contact sensor (21) is arranged, and has an extended position (22), in which the setting tool cannot be triggered and an actuation position (23), in which the setting tool can be triggered. A muzzle surface (24) on the muzzle part (20) serves in the normal application of the setting tool on a receiving material (U). In addition, a muzzle opening (25) is arranged on the muzzle part, relative to which at least two tilt points (K1, K2) are arranged opposite to each other in the muzzle region of the setting tool. The setting tool in the pressing contact position can be pivoted about these tilt points (K1, K2). For improving this type of setting tool, it is proposed that the first tilt edge (K1), which lies on the side of the muzzle opening (25) facing away from the pressing contact sensor (21), relative to a plane (E1) defined by the muzzle surface (24) and the tilt edge (K2), is displaced rearward by the dimension (n) towards the housing part. The second tilt edge (K2) thus lies on the same side of the muzzle opening (25) as the pressing contact sensor (21).

### BACKGROUND OF THE INVENTION

The present invention relates to a setting tool of the type for driving fastening elements into a receiving material. This type of setting tool can be operated with solid, gaseous or liquid fuels or even with air or compressed air. In the internal combustion driven setting tool a setting piston is driven using high-load combustion gases. Fastening elements can be driven into the receiving material using the setting piston.

Out of safety considerations, in setting tools that are operated using highly loaded gases, it is common to install a contact safety device, which has a pressing contact sensor, which projects in the muzzle region of the setting tool. In order to make possible triggering of the setting tool, at least one pressing contact sensor must, by pressing contact on the receiving material, be brought into an triggering position.

In the case of a Hilti DX750 setting tool having MX75 equipment, two pressing contact pins project from the muzzle region and are arranged at the same distance relative to the setting axis. If the DX 750 is tilted out of the normal to the receiving material, the stand plate tilts about an edge, which is further distanced from the setting axis than the pressing contact pin itself. The edge, which is present at two sides of the stand plate, is arranged on an extension projecting from the stand plate. With inclined pressing on a receiving material, the active pressing contact pin lifts off at a specific angle of inclination from the receiving material and is run out of the device by a spring force. After it has exited the device by a certain critical dimension, the setting operation by the device is impaired as a consequence. If the device is inclined in the other direction out of the normal to the receiving material, the other pressing contact pin takes over and the other edge takes on the identical task. The trigger window (the permissible angle of inclination to the normal to the receiving material) is the same in both directions based on the use of two identical pressing contact pins and edges arranged in the same geometry.

The drawback in this solution is the elevated mass of the muzzle part because of the arrangement of two pressing contact sensors together with the associated similar structure.

In setting tools, DE 40 32 200 C2 teaches the use of only one pressing contact sensor in the form of a pressing contact pin. This pressing contact sensor is arranged eccentrically (i.e., lateral to the setting axis) on the stand plate of the device. If the setting tool is laterally tilted in the direction of the pressing contact pin facing away from the stand plate, the pressing contact pin raises from the receiving material, so that from a certain angle of inclination of the tool to the normal of the receiving material, a setting operation with the tool is prevented.

However, the drawback in this case is the fact that, when the setting tool is inclined in the opposite direction; that is, over the pressing contact pin as pivot edge, the pressing contact pin does not lift despite exceeding the critical angle. Accordingly, despite exceeding the critical angle setting can be done with the setting tool, which under certain circumstances, results in unsatisfactory fastening quality.

### SUMMARY OF THE INVENTION

The object of the present invention is, therefore, to provide a setting tool of the aforementioned type, which can be tilted relative to the surface of the receiving materials.

According to the invention the object is achieved by a setting tool for fastening elements into a receiving material surface where the surface of the receiving material is not normal to the setting axis, to which the following special significance is ascribed. According thereto, if one of the available tilt points, which lies on the side of the muzzle opening facing away from the pressing contact sensor, relative to a plane defined by the muzzle surface and the other tilt point is set back by a dimension n relative to the housing part, whereby the second tilt point on the same side of the muzzle opening is situated like the pressing contact sensor. By virtue of this specific setting back of the first tilt point situated closer to the setting axis relative to the second tilt point, the muzzle surface can, by the use of a pressing contact sensor arranged eccentrically to the muzzle part, such as a pressing contact pin, the same triggering window can be realized for the setting tool in both lateral tilt directions. In other words, the setting tool can be tilted both over the first tilt point and over the second tilt point within an identical angular range, within which the setting tool can still be triggered, because the one available pressing contact sensor or pressing contact pin releases a setting operation. If the device is, however more inclined at the tilt point than the maximum allowable tilt angle, then the pressing contact sensor or the pressing contact pin moves as far out of its guide, that a setting operation with the setting tool is no longer possible.

In an advantageous geometric configuration, the two tilt points, the muzzle opening of the setting tool and the pressing contact sensor lie essentially in a straight line relative to each other.

It is further advantageous, if the second tilt point has a larger radial separation from the setting axis than the first tilt point. When this is done, on the part of the second tilt point, structural space for off-center arrangement of the pressure contact sensor is made available.

It can further be of advantage, if an inclined surface is arranged at the muzzle opening towards the tilt point. Ideally, this inclined surface has an inclination, which corresponds to the inclination of the setting tool at the maximum possible setting angle, at which a setting operation is still possible with a tilting over the first tilt point.

In a stable embodiment of the setting tool, the tilt points are arranged on spur-like projections of the muzzle part. As a result of the spur-like configuration, furthermore, material economies and a reduction in weight can be achieved, because the muzzle part does not have to be configured as a solid in the front region of the setting tool.

It is further advantageous, if an inclined surface increasing in the direction towards the setting axis is arranged on the projection carrying the first tilt point. If the setting tool is tilted over the first tilt point up to the maximum possible setting angle, then this inclined surface can abut compactly on the receiving material (insofar as the concerned receiving material is a flat surface).

In this case it is further advantageous if the inclined surface, which carries the first tilt point, lies essentially in a plane with the inclined surface at the muzzle opening.

Other advantages and procedures of the invention will become apparent from the claims, the following description and the drawings. The invention is represented in an exemplary embodiment in the drawings,

### BRIEF DESCRIPTION OF THE DRAWING

FIG. 1 is a schematic representation of a setting tool according to the invention in side view;

FIG. 2 schematically represents the muzzle part of the setting tool of FIG. 1;

FIG. 3 schematically represents the muzzle part of the setting tool of FIG. 1 in the pressing contact position on a receiving material and inclined to the side without the pressing sensor;

FIG. 4 schematically represents the muzzle part of the setting tool of FIG. 1 in the pressing contact position on the surfaces of a receiving material and inclined to the side with the pressing sensor;

### DETAILED DESCRIPTION OF THE INVENTION

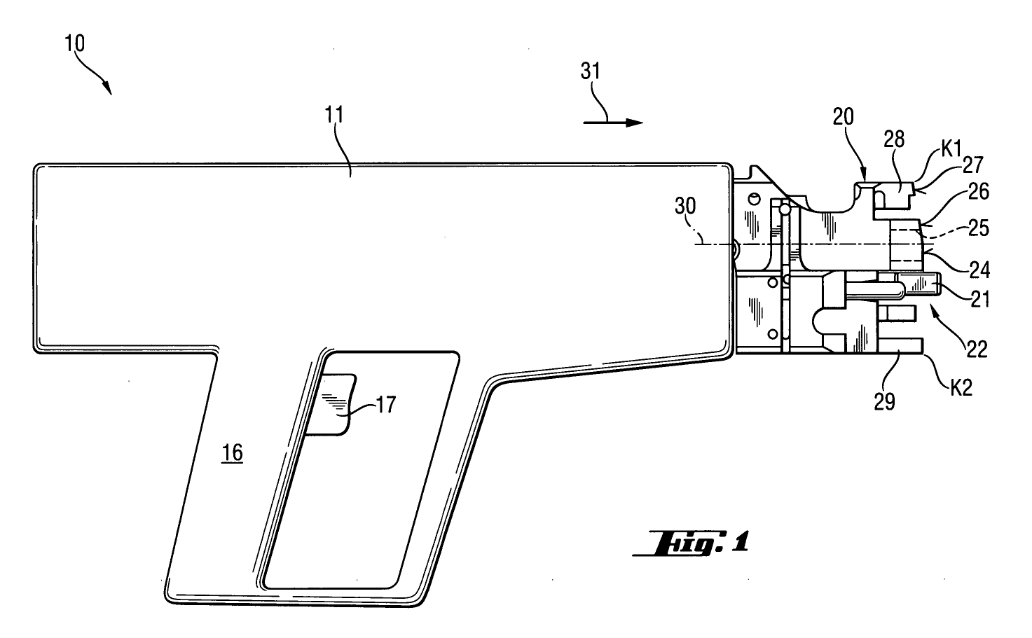

FIGS. 1 to 4 reproduces by way of example an internal combustion operated setting tool 10. The setting tool has a setting mechanism arranged in a one or multiple-part housing part 11 with a driving piston for driving fastening elements into a receiving material (not shown here). For triggering a setting operation, a trigger switch 17 is arranged on the setting tool 10, on a hand grip 16 of the setting tool.

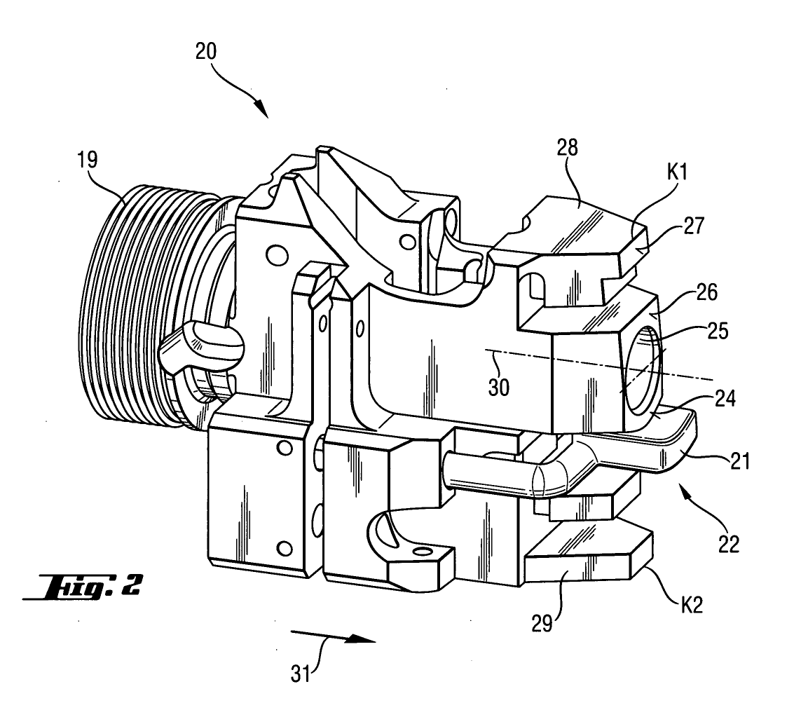

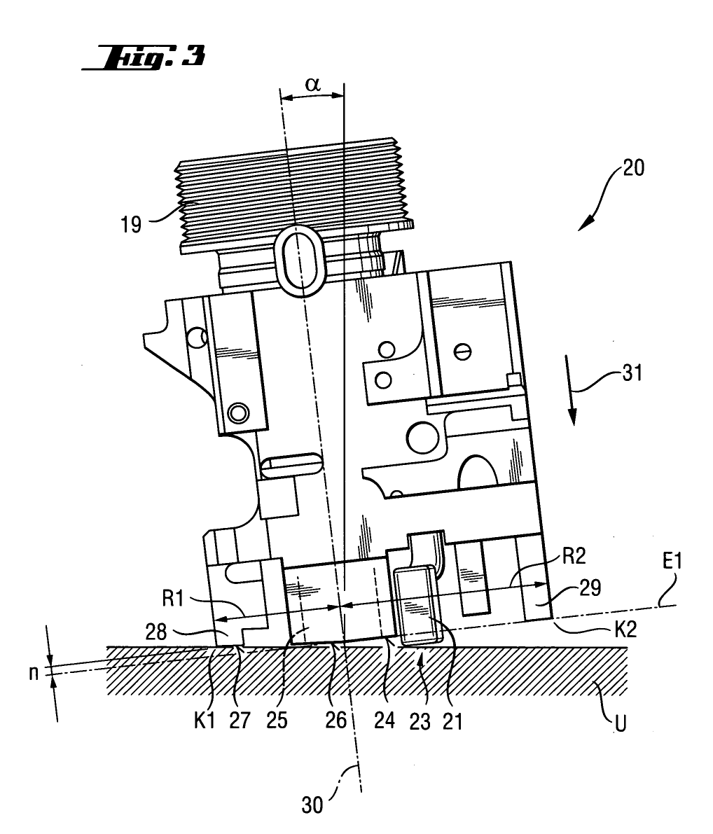

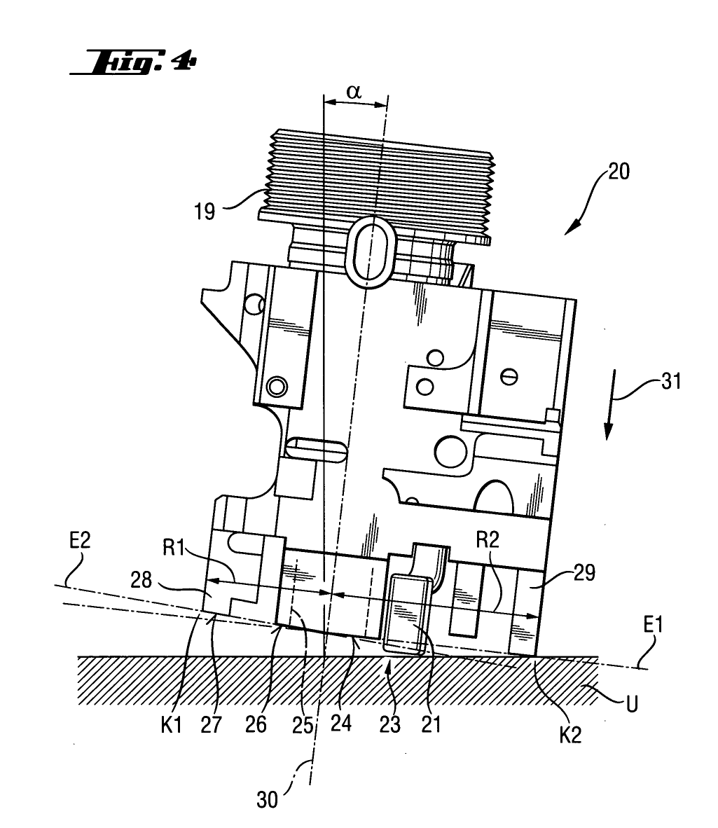

A muzzle part 20 is arranged on the setting tool 10 in the housing part in the setting direction 31, the muzzle part communicating with the setting mechanism (not shown here) (compare in particular FIG. 1). This muzzle part 20 is; for example, connected via a threaded connection 19 with the rest of the setting mechanism on the inside of the housing part 11. The muzzle part 20 has a muzzle opening 25, through which a fastening element can be driven during a setting operation and driven into a receiving material, when the setting tool is pressed against the receiving material. In addition, a muzzle surface 24 and a projection 29 are situated at the muzzle opening 25, over which the setting toll can be applied perpendicularly to the setting axis 30 or the setting tool (compare FIGS. 3 and 4) to a receiving material U. In the non-pressing position of the setting tool—as can be seen in FIGS. 1 and 2—a pressing contact sensor 21—which is here configured as a pressing contact pin—projects outwardly from the muzzle part 20. In this extended position 22 of the pressing contact sensor 21 a setting operation with the setting tool 10 is not possible. Upon pressing contact of the setting tool 10 perpendicularly on a receiving material surface, the pressing contact sensor 21 is completely urged inwardly until it closes flush with the muzzle surface 24. A setting operation can then be triggered by actuation of the trigger switch.

In addition, a first projection 28 is arranged at the muzzle part 20. A first tilt point K1 is situated at this projection 28, whilst a second tilt point K2 is situated at a second projection 29 apparently diametrically opposite. In addition, an inclined surface 27 is arranged on the first projection 28 (compare in particular FIGS. 3 and 4), which lies substantially in a plane E2 with an inclined surface 26 in the region of the muzzle opening 25 (compare in particular FIG. 4). The two tilt points K1 and K2, the muzzle opening 25 as well as the pressing contact sensor 21 lie, in the present setting tool 10, on a straight line. The radial distance R1 of the first tilt point K1 to the setting axis 30 is in this case less than the radial distance R2 of the second tilt point K2 to the setting axis 30. If a plane E1 is applied to the muzzle surface 24 and the tilt point K2 on the projection 29, then the tilt point K1 on the projection 28 is moved back relative to the plane E1 by the dimension n in the direction of the housing part 11. By virtue of this backward displacement of the tilt point K1, the result is that the maximum angle of inclination a when tilting over the tilt point K1 and when tilting over the tilt point K2 until a switching of the pressing contact sensor 21 is the same (compare FIGS. 3 and 4). In other words, that the setting window or the angular range within which a setting operation can still be carried out with the setting tool, with a tilting of the setting tool at the tilt points K1 and K2 is the same. The first and second tilt points K1 and K2 are accordingly configured in particular as edges, so that a simultaneous tilting or inclination of the tool outside of the extended plane formed by the tilt points K1 and K2 is minimized and the user is able to provide a precise application of the setting tool upon the receiving material U even with an inclined setting tool. FIGS. 3 and 4 show the muzzle part 20 inclined at the maximum possible setting angle α about the first tilt point K1 (FIG. 3) and second tilt from K2 (FIG. 4), respectively. The pressing contact sensor 21 naturally travels somewhat out of the muzzle part but the pressing contact sensor 21 is still not yet actuated and is still situated in its actuation position 23, in which a triggering of the setting tool is possible. If the angle α is increased and the setting tool accordingly more inclined over the tilt point K1 or K2, then the pressing contact sensor 21 moves so far out of the muzzle part 20, until triggering of the setting tool is no longer possible. The pressing contact sensor 21 is then situated again in its extended position 22, as can be seen in FIGS. 1 and 2.

1. A setting tool for driving fastening elements into a receiving material (U) comprising a housing part (11) with a setting axis (30), a muzzle part (20) at a leading end of the housing part (11), a pressing contact sensor (21) positioned at a leading end of said muzzle part (20) and having an extended position (22) where the setting tool (10) can not be triggered and an actuation position (23) where the setting tool (10) can be actuated, said muzzle part (20) has a muzzle surface (24) perpendicular to the setting axis (30), for application against the receiving material (U), said muzzle part (20) in the region of the muzzle surface (24) having at least two tilt points (K1, K2) spaced radially outwardly from a muzzle opening (25) of said muzzle part (20) each on a diametrically opposite side of said muzzle opening (25) whereby the pressing contact sensor of said setting tool (11) in the actuating position can be pivoted about said tilt points (K1, K2) said first tilt point (K1) lies on a side of said muzzle opening (25) spaced from said contact sensor (21) and is spaced rearwardly relative to a plane (E1) extending in the plane of the muzzle surface (24) and in the plane of the second tilt point (K2) by a dimension (n) towards said housing part (11) with said second tilt point (K2) located on the same side of the muzzle opening (25) as the contact sensor (21).

2. A setting tool, as set forth in claim 1, wherein a radial distance (R2) of said second tilt point (K2) from said setting axis (30) is greater than a radial distance (R1) of said first tilt point (K1) from said setting axis (30).

3. A setting tool, as set forth in claim 1, wherein an inclined surface (26) in the region of said muzzle opening (25) is inclined towards said first tilt point (K1).

4. A setting tool, as set forth in claim 1, wherein said first tilt point (K1) and said second tilt point (K2) are arranged as spur-like projections (28, 29) on said muzzle part (20).

5. A setting tool, as set forth in claim 4, wherein an inclined surface (27) is located on said spur-like projection (29) containing said first tilt point (K1) and is inclined in the setting direction towards the setting axis (30).

6. A setting tool, as set forth in claim 5, wherein the inclined surface (27) on said spur-like projection (2) is located essentially in a plane (E2) with said inclined surface (26) at said muzzle opening (25).
